(19) United States
(12) Patent Application Publication
(10) Pub. No.: US 2008/0192496 A1
(43) Pub. Date: Aug. 14, 2008

(54) Lamp System For Vehicle

(75) Inventors: Kiyotaka Mochizuki, Shizuoka (JP); Naohisa Tatara, Shizuoka (JP)

Correspondence Address: FISH & RICHARDSON P.C., P.O. BOX 1022, MINNEAPOLIS, MN, 55440-1022, US

(73) Assignee: Koito Manufacturing Co., Ltd., Tokyo (JP)

(21) Appl. No.: 12/025,148

(22) Filed: Feb. 4, 2008

(30) Foreign Application Priority Data
Feb. 8, 2007 (JP) 2007-028763

(51) Int. Cl. B60Q 1/00

(52) U.S. Cl. 362/466

(57) ABSTRACT

A vehicle lamp system includes lamps RHL and LHL. The lamp system can switch at least to a low beam distribution and a motorway light distribution. A light distribution switching control portion CONT for switching the light distribution based on operational information of the vehicle switches to the low beam distribution when it is determined that the vehicle speed is less than a predetermined speed in the motorway light distribution and a predetermined light distribution switching condition is satisfied. If presence of an obstacle is confirmed so as to apply a deceleration, it is possible to prevent the obstacle from being undetected by switching to the low beam distribution. Thus, it is possible to reliably keep away from the obstacle, thereby ensuring stable operation.

The present disclosure claims the benefit of priority of Japanese Patent Application No. 2007-028763, filed on Feb. 8, 2007. The contents of that application are incorporated herein by reference.

### TECHNICAL FIELD

The present disclosure relates to a lamp system for a vehicle which serves to control a light distribution of a headlamp for illuminating a forward part of the vehicle, and more particularly to a lamp system for a vehicle which enhances safety during high speed operation.

### BACKGROUND

In recent cars, there has been proposed a lamp system for a vehicle which automatically switches a light distribution of a headlamp corresponding to the operating state of the car to enhance safety while driving. For example, published Japanese patent document JP-A-2006-40785 proposes a technique for changing a position of a light source or a shade provided in a headlamp, thereby switching a light distribution of the headlamp. Moreover, published Japanese patent document JP-A-2006-100132 proposes a technique for changing a position of an additional reflector provided in a headlamp, thereby switching a light distribution of the headlamp. Moreover, according to the foregoing patent documents, there is obtained a light distribution referred to as an intermediate light distribution pattern, which is close to the middle of conventional low and high beam distributions in location or a light distribution referred to as a motorway light distribution. (The light distribution of this type will be hereinafter referred to as a motorway light distribution.) The motorway light distribution is basically a low beam distribution and has a higher luminous intensity on the center of the light distribution than that in the low beam distribution. Furthermore, an optic-axial angle on the center of the light distribution is turned slightly upward from the low beam distribution. As described in the JP-A-2006-100132, it is possible to illuminate a forward distant region of a car to be brighter than the low beam distribution, without interfering with the operator of a car traveling in the opposing lane. It is thus possible to enhance safety by switching to the motorway light distribution during high speed operation.

As in JP-A-2006-40785, it is possible to propose a structure so as to provide a light distribution switching control portion for switching the light distribution of the headlamp when switching to the motorway light distribution during high speed operation of a car, for example, and to control a position of an additional reflector of the headlamp when a speed of the car is equal to or higher than a predetermined speed, thereby switching the light distribution to the motorway light distribution. With the structure, when the car operating with a low beam distribution at intermediate and low speeds goes to a suburb and transitions to high speed operation, the light distribution switching control portion automatically can switch the headlamp to the motorway light distribution upon recognizing that the vehicle speed is equal to or higher than the predetermined speed. Without any action by the driver, the forward and distant region of the car can be illuminated brightly so that safe high speed operation can be achieved. When the car transitions from high speed operation to intermediate and low speed operations, such as traveling in an urban area, the headlamp is switched to the low beam distribution by means of the light distribution switching control portion to increase illumination in a region immediately before the car so that safe operation can be realized in the urban area.

### SUMMARY

When a lamp system for switching to the low beam distribution and the motorway light distribution is constructed based on the vehicle speed, the following problems can be caused during operation with the motorway light distribution, based on investigations of the inventor.

(a) When a forward obstacle is recognized during operation with the motorway light distribution and deceleration is performed to keep away from the obstacle, the light distribution is switched into the low beam distribution when the vehicle speed is reduced to lower than a predetermined speed and the forward illumination of the car is reduced making it difficult to identify the obstacle.

(b) When deceleration occurs to avoid a danger during operation with the motorway light distribution, switching to the low beam distribution is performed automatically. Even if acceleration is started again after the danger is avoided, the low beam distribution is maintained until a predetermined speed is reached, and a delay is generated to ensure safety in the forward part of the car during the transition to the high speed operation.

(c) When the speed is changed in an up-down operation over a slope, the low beam distribution and the motorway light distribution often are switched in response to the change in the speed so that the driver feels uncomfortable and forward visibility deteriorates.

In various implementations, the disclosed lamp system can eliminate the drawbacks (a) to (c) and provide a lamp system for a vehicle which ensures safety of a vehicle through a motorway light distribution.

In one aspect, the invention provides a lamp system for a vehicle comprising a lamp for a vehicle which can switch between at least a low beam distribution and a motorway light distribution, and a light distribution switching control portion for switching the light distribution based on information about the state of operation of the vehicle, wherein the light distribution switching control portion switches to the low beam distribution when it determines that the vehicle speed is lower than a predetermined speed in the motorway light distribution and a predetermined light distribution switching condition is satisfied.

According to another aspect of the invention, when the vehicle speed is reduced to lower than the predetermined speed in the motorway light distribution, switching to the low beam distribution is not automatically carried out until a predetermined light distribution switching condition is satisfied. When a predetermined light distribution switching condition is properly set to confirm the presence of an obstacle in a forward distant region of the car, it is possible to prevent failure to identify the presence of the obstacle due to switching to the low beam distribution and it is possible to keep away reliably from the obstacle, thereby ensuring safety while traveling.

In the description below, it is assumed, for a light distribution switching condition, that a predetermined time passes after the vehicle speed is reduced to less than a predetermined speed. A motorway light distribution is maintained for a predetermined time. Therefore, it is possible to confirm the presence of and keep away from an obstacle. By varying the predetermined time corresponding to the speed of the vehicle or its acceleration, it is possible to confirm the presence reliably and keep away from the obstacle even at a different vehicle speed.

In the following description, it is assumed for the light distribution switching condition, that the speed of the vehicle increases. Since the obstacle is confirmed and kept away until an increase in the vehicle speed, the motorway light distribution is maintained, and the obstacle can be confirmed and kept away during that time. When the presence of the obstacle is confirmed and the vehicle is kept away and the speed of the vehicle is increased, it is possible to perform proper operation by setting a low beam distribution corresponding to the vehicle speed.

In the description below, it is assumed for the light distribution switching condition, that deceleration of the vehicle is less than a predetermined value (i.e., is smaller than the predetermined value). If deceleration of the vehicle is equal to or higher than the predetermined value, it is estimated that there is an emergency. During that time, therefore, the motorway light distribution is maintained and the presence of the obstacle can be confirmed and the vehicle kept away. When presence of the obstacle confirmed and the vehicle is kept away and deceleration of the vehicle is less than the predetermined value, that is, the deceleration is reduced and the speed is thus increased, it is possible to perform proper operation by setting the low beam distribution corresponding to the vehicle speed.

In some implementations of the invention, a light distribution switching control portion includes obstacle detecting means for detecting an obstacle ahead of the vehicle, and the light distribution switching condition indicates when the obstacle is not detected by the obstacle detecting means. Also, in the case in which the driver is not convinced of the presence of the obstacle, the motorway light distribution is maintained to enable the presence of the obstacle to be confirmed so that the vehicle can be kept away by the driver when the obstacle is detected by the obstacle detecting means.

### BRIEF DESCRIPTION OF THE DRAWINGS

FIG. 1 is a block diagram showing a structure of a system according to the invention.

FIG. 2 is a sectional view showing a headlamp.

FIG. 3 is a view showing an optical path in a state in which a light distribution of the headlamp is switched.

FIG. 4 is a typical plan view showing the light distribution of the headlamp.

FIG. 5 is a flowchart for explaining a system based on a first improving condition.

FIG. 6 is a flowchart for explaining a system based on a second improving condition.

FIG. 7 is a flowchart for explaining a system based on a third improving condition.

FIG. 8 is a flowchart for explaining a system based on a fourth improving condition.

FIG. 9 is a flowchart for explaining a system based on a fifth improving condition.

FIG. 10 is a flowchart for explaining a system based on a sixth improving condition.

FIG. 11 is a flowchart for explaining a system based on a seventh improving condition.

### DETAILED DESCRIPTION

### EXAMPLE 1

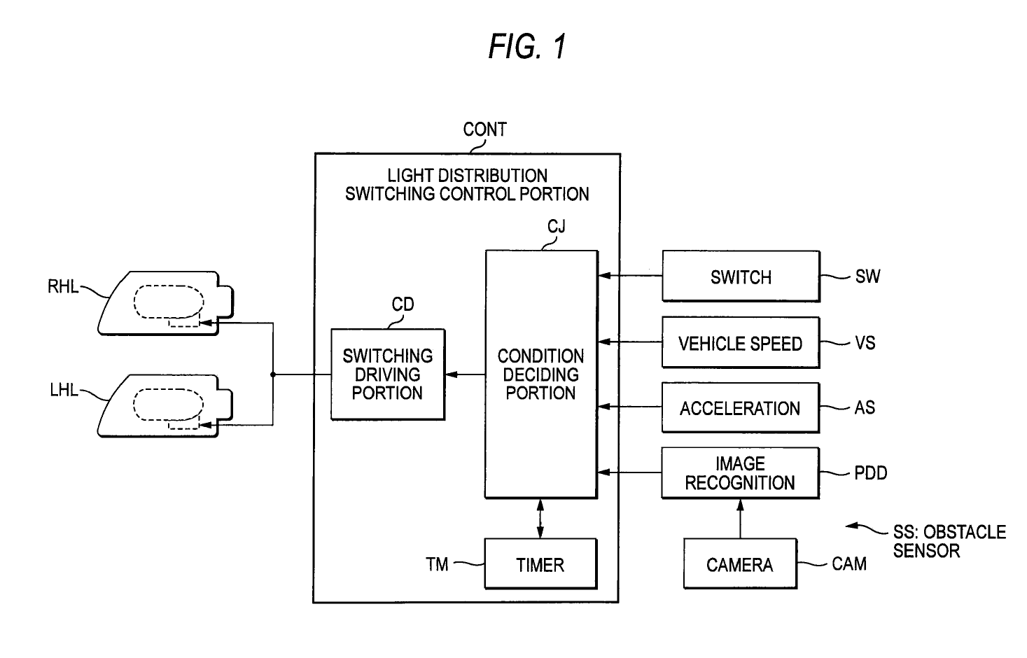

FIG. 1 is a block diagram showing a structure according to an example 1. Headlamps LHL and RHL on the left and right in a front part of a car can carry out switching to an optional light distribution, that is, switching to a low beam distribution, a motorway light distribution and a high beam distribution. A light distribution switching control portion CONT for switching the light distribution is connected to the headlamps LHL and RHL. The light distribution switching control portion CONT performs control to switch the light distribution based on the vehicle speed. A light distribution change-over switch SW to be changed by operation of the driver, a vehicle speed sensor VS for detecting the vehicle speed of the car, an acceleration sensor AS for detecting an acceleration/deceleration of the car, and an obstacle sensor SS for detecting an obstacle ahead of the car, are connected to the light distribution switching control portion CONT. The light distribution switching control portion CONT is arranged to recognize a switching state of the light distribution change-over switch SW, to recognize the vehicle speed of the car and the operational information based on outputs of the sensors VS, AS and SS, to decide, based on the recognitions, whether a predetermined condition is satisfied or not, and to switch the light distributions of the headlamps LHL and RHL when it is determined that the condition is satisfied.

The light distribution change-over switch SW is also referred to as the Dumas switch. It changes to a “high beam” or a “low beam” by manual operation of the driver, and outputs the switching information to the light distribution switching control portion CONT. The vehicle sensor VS detects current vehicle speed information of the car and outputs the vehicle speed information to the light distribution switching control portion CONT. The acceleration sensor AS detects the current acceleration and deceleration of the car and outputs the information to the light distribution switching control portion CONT. The obstacle sensor SS includes an imaging camera CAM for picking up an image ahead of the car and image recognizing means PDD for analyzing the image picked up by the imaging camera CAM and recognizing an obstacle, and outputs the information to the light distribution switching control portion CONT upon recognizing the obstacle.

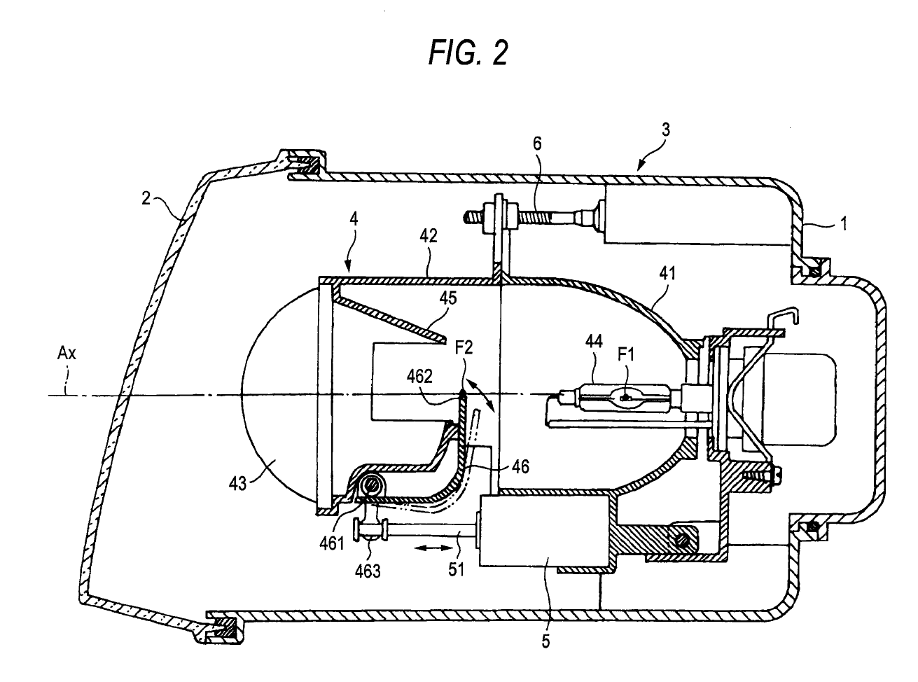

The left and right headlamps LHL and RHL have the same structures: a projector type lamp 4 is provided in a lamp housing 3 constituted by a lamp body 1 and a transparent cover 2 and is supported in the lamp body 1 through an aiming mechanism 6, as shown in FIG. 2. A lamp having almost the same structure as the lamp disclosed in JP-A-2006-40785 is used for the projector type lamp 4, which includes a reflector 41 having the shape of a rotating elliptical container having a first focal point F1 and a second focal point F2, a cylindrical holder 42 linked to a front opening of the reflector 41, a projection lens 43 attached to a front edge portion of the holder 42, a discharge bulb 44 serving as a light source which is inserted and supported in the reflector 41, and a fixed shade 45 and a movable shade 46 which are inserted in the holder 42 and serve to shield a part of a light projected from the projection lens 43. As the structure of the aiming mechanism 6 and that of each of the reflector 41, the holder 42, the projection lens 43, the discharge bulb 44 and the fixed shade 45 in the projector type lamp 4 are well known, detailed description will be omitted. The movable shade 46 is tiltable within an operational angle range in the direction of the lamp optical axis Ax in the holder, and the light distribution can be switched corresponding to the tilting angle.

More specifically, the movable shade 46 includes a shade plate capable of shielding a region in a holder at a lower side from the lamp optical axis Ax, and an upper edge portion 462 is supported tiltably to fall rearward from the lamp as shown in a chain line of the drawing by setting, as a support point, a horizontal shaft 461 provided in a lower part of the movable shade 46. Moreover, a tip of a plunger 51 of a motor driving mechanism 5 supported on a part of the reflector 41 is coupled to a stem 463 provided in a part of the movable shade 46. In the motor driving mechanism 5, the tip position of the plunger 51 is changed into a longitudinal direction that is parallel with the lamp optical axis Ax by controlling a conduction to a motor, and the stem 463 is rotated by setting the horizontal shade 461 to be a support point with a change in the tip position of the plunger 51 so that a tilting angle of the movable shade 46 provided integrally with the stem 463 is varied. The upper edge portion 462 of the movable shade 46 has an initial position set to be a vicinal position of the second focal point F2 of the reflector 41 and is tilted by the motor driving mechanism 5 rearward and downward from the initial position.

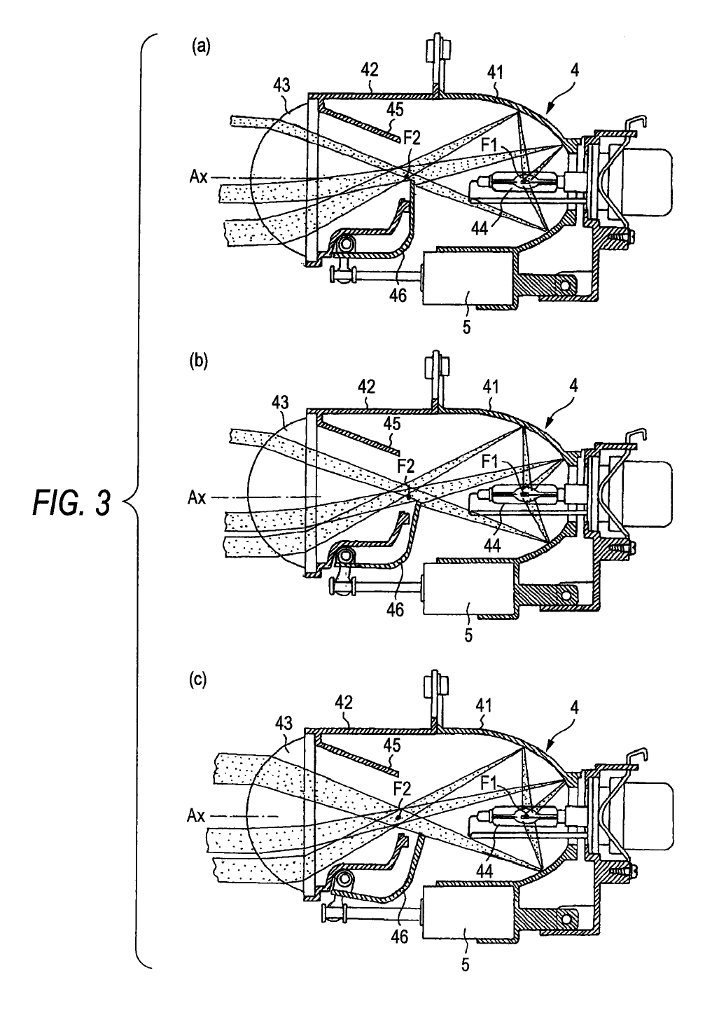

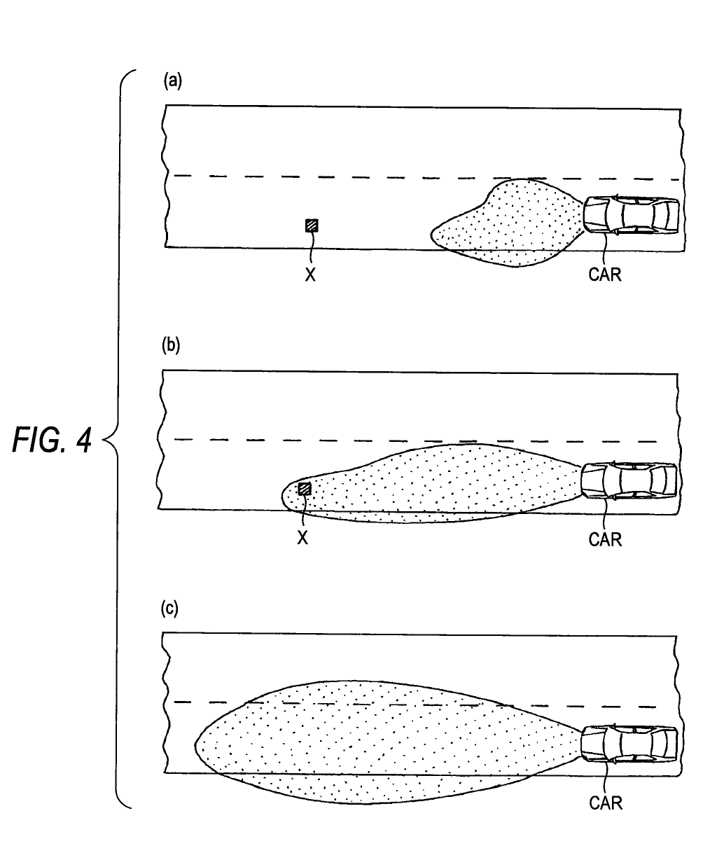

In the projector type lamp, as shown in FIG. 3, light emitted from the light emitting center of the discharge bulb 44 positioned in the vicinity of the first focal point F1 of the reflector 41 is reflected through the reflector 41 and is directed to the second focal point F2, and thereafter is transmitted through the projection lens 43 and is projected forward. Stray light in the light reflected through the reflector 41 is shielded by the fixed shade 45. When the upper edge portion 461 of the movable shade 46 is placed in the initial position as shown in FIG. 3(a), most of the light directed to the second focal point F2 and directed upward from the lamp optical axis Ax is shielded by the movable shade 46 and part of the light directed downward also is shielded by the movable shade 46. Therefore, there is obtained a low beam distribution for illuminating a region provided just ahead of the lane of the car CAR or an intermediate region as shown in FIG. 4(a).

When the tip position of the plunger 51 is moved forward by the solenoid mechanism 5 so that the upper edge portion 462 of the movable shade 46 is tilted at a maximum rearward and downward from the initial position as shown in FIG. 3(c), any of the light reflected through the reflector 41, directed to the second focal point F2 and directed downward from the lamp optical axis Ax, is rarely shielded. Furthermore, an amount of the shielded light directed upward also is reduced. As shown in FIG. 4(c), therefore, there is obtained a high beam distribution for illuminating a wide region from a place positioned immediately ahead of the lane of the car CAR to a distant spot or region including the opposing lane.

When the upper edge portion 462 of the movable shade 46 is tilted to a middle position between an initial position in the “low beam distribution” and a maximum tilting position in the “high beam distribution” as shown in FIG. 3(b), the amount of shielding of the light directed downward from the lamp optical axis Ax is less than the “low beam distribution” and is greater than the “high beam distribution,” and the amount of shield of the light directed upward is also greater than the “high beam distribution.” Therefore, there is obtained a motorway light distribution for illuminating a forward middle or distant region in the lane of the car CAR, as shown in FIG. 4(b).

With reference to FIG. 1, the light distribution switching control portion CONT includes a condition deciding portion CJ, a switching driving portion CD and an internal timer TM. The condition deciding portion CJ decides light distribution switching conditions of the headlamps LHL and RHL on the basis of the switching information of the light distribution change-over switch SW and operational information about the car based on each of the sensor outputs of the vehicle speed sensor VS, the acceleration sensor AS and the obstacle sensor SS. The decision is carried out based on next basic conditions (B1) to (B3).

(B1) “High beam distribution decision” when the light distribution change-over switch SW is changed to “high beam,”

(B2) “Low beam distribution decision”: when the light distribution change-over switch SW is changed to “low beam,” and

(B3) “Motorway light distribution decision” when the light distribution change-over switch SW is changed to “low beam” and the vehicle speed is equal to or higher than a predetermined speed (for example, 60 km/h).

When the condition deciding portion CJ determines that any of the basic conditions (B1) to (B3) of the “high beam distribution,” the “low beam distribution” and the “motorway light distribution” is satisfied, it sends each predetermined signal to the switching driving portion CD, and the switching driving portion CD controls the motor driving mechanism 5 for the headlamps LHL and RHL in response to an input signal to control a change in the tip position of the plunger 51, thereby controlling the tilting angle of the movable shade 46, that is, a tilting position of the upper edge portion 462 of the movable shade 46. Consequently, a light distribution control for switching the “high beam distribution,” the “low beam distribution” and the “motorway light distribution” is performed corresponding to the tilting angle of the movable shade 46 as described above.

In the “motorway light distribution” shown in FIG. 4(b), particularly, it is possible to illuminate a forward distant region of the car without interfering with the driver of a car traveling in an opposing lane when the car is in high speed operation. Therefore, the presence of an obstacle X present in the car's lane can be confirmed at an early stage. Thus, the “motorway light distribution” is very effective for ensuring safe operation by avoiding danger, for example, preventing a collision with the obstacle. In the “low beam distributions shown in FIG. 4(a), the illumination mainly is carried out in a region placed immediately ahead of the car. For this reason, it is hard to confirm the presence of the obstacle X in the lane until a place immediately before the obstacle X. Thus, it is difficult to keep away from the obstacle.

In example, 1, when the “motorway light distribution” is set, that is, the light distribution change-over switch SW is set to the “low beam” and there is carried out a change from an operational state in which the vehicle speed is equal to or higher than a predetermined speed to a state in which the vehicle speed is reduced to less than the predetermined speed as described above, the condition deciding portion CJ determines that the basic condition (B3) is not satisfied, that is, the basic condition for switching into the “low beam distribution” is satisfied. In this case, if it is determined that any of the following improving conditions (R1) to (R7) is satisfied, a switching signal for switching the “motorway light distribution” to the “low beam distribution” is sent to the switching driving portion CD.

(R1) When the vehicle speed is less than the predetermined speed for a predetermined time (i.e., duration).

(R2) The “predetermined time” of the improving condition (R1) is varied depending on the speed of the vehicle or the acceleration. More specifically, when the speed or the acceleration is high, the time is shortened.

(R3) When the car travels a predetermined distance after the vehicle speed is less than the predetermined speed.

(R4) When the speed of the car is increased.

(R5) When the deceleration of the car is less than a predetermined value.

(R6) When an obstacle is not detected by obstacle detecting means.

(R7) When the vehicle speed is equal to or less than a second predetermined speed which is even less than the predetermined speed.

### [Improving Condition R1]

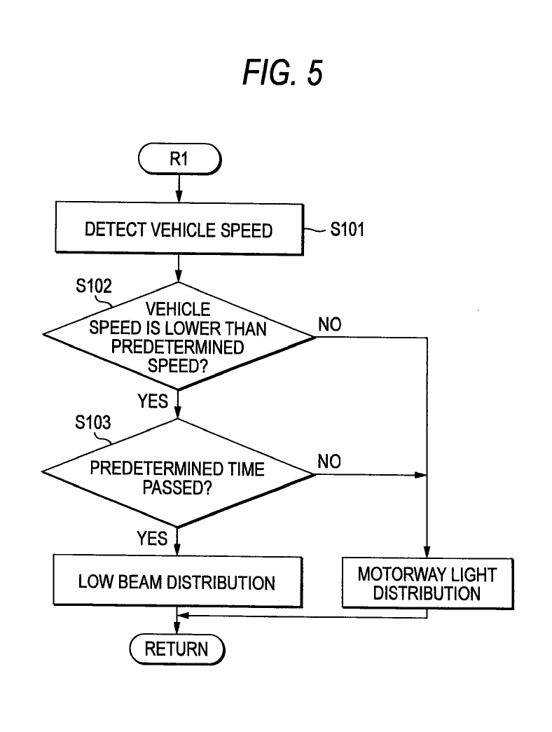

As shown in the flow of FIG. 5, when a car travels at, or faster than, a predetermined speed, which is close to high speed operation, the light distribution switching control portion CONT detects the vehicle speed (S101) and determines whether or not the detected vehicle speed is equal to or greater than the predetermined speed (S102). When the detected vehicle speed is equal to or greater than the predetermined speed, the headlamps LHL and RHL are switched to the.“motorway light distribution.” More specifically, the switching driving portion CD drives the motor driving mechanism 5 in response to a switching signal from the condition deciding portion CJ, and the movable shade 46 is tilted rearward to position the upper edge portion 461 slightly rearward and downward from an initial position. Consequently, it is possible to illuminate a forward and distant region of the vehicle's lane and to confirm the presence of an obstacle which in the same region. During operation in the “motorway light distribution,” when the presence of an obstacle is confirmed and the driver thus decelerates so that the vehicle speed is less than the predetermined speed, for example, it is decided that the basic condition (B3) does not satisfy the “motorway light distribution,” and one of the conditions for switching to the “low beam distribution” is satisfied in the light distribution switching control portion CONT, and subsequently, the improving condition (R1) is decided (S103). More specifically, the condition deciding portion CJ determines the duration from the time that the vehicle speed is less than the predetermined speed to the present time through the internal timer TM, and decides that the improving condition (R1) is satisfied when the state in which the vehicle speed is less than the predetermined speed is continuously maintained for a predetermined time. Consequently, a predetermined switching signal is provided from the condition deciding portion CJ, and the switching driving portion CD drives the motor driving mechanism 5 based on the signal to forward tilt the movable shade 46, thereby returning the upper edge portion 461 to the initial position to switching to the “low beam distribution”.

Also, when the driver confirms the presence of the obstacle X and decelerates during operation in the “motorway light distribution” so that the vehicle speed is less than the predetermined speed as shown in FIG. 4(b), switching to the “low beam distribution” is not performed immediately, but instead the “motorway light distribution” is maintained for a predetermined time. Therefore, the state in FIG. 4(b) in which the illumination of the obstacle X is carried out is held and the driver can avoid the danger. If switching to the “low beam distribution” is carried out immediately when the vehicle speed is less than the predetermined speed, the illumination of the forward distant region of the car is lost as shown in FIG. 4(a), and it is hard to confirm the presence of the obstacle X in the region. Consequently, it is difficult to avoid the danger. When the predetermined speed is set to be 60 km/h, it is preferable that the predetermined time should be two to three seconds. If the time is shorter than the predetermined time, switching to the “low beam distribution” is performed before the car reaches the place where the obstacle X is located, and it is difficult to avoid the danger.

### [Improving Condition R2]

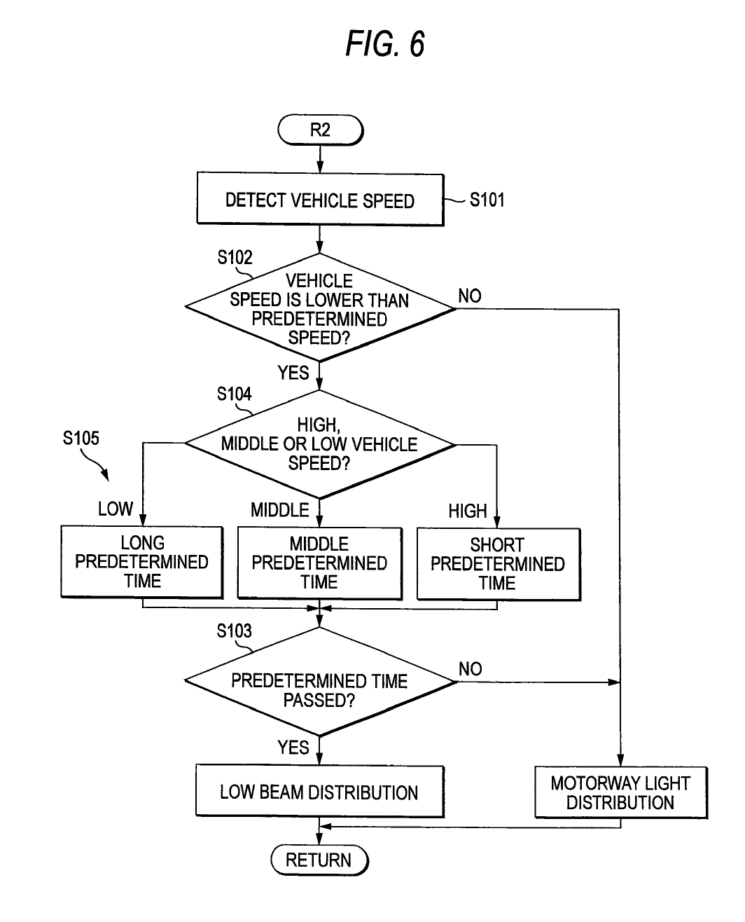

As shown in a flow of FIG. 6, the distance the car travels before a predetermined time passes after the vehicle speed is set to be less than the predetermined speed is expressed as a product of the vehicle speed and the predetermined time in the Improving Condition R1. When the distance from the car to the confirmed obstacle is almost constant, the time required for avoiding the obstacle varies depending on the reduced vehicle speed. Accordingly, the predetermined time is shortened when the vehicle speed is high, and the predetermined time is lengthened when the vehicle speed is low. Consequently, it is possible to hold the “motorway light distribution” reliably before the car avoids the obstacle regardless of the reduced vehicle speed. Herein, the vehicle speed is divided into three stages (low, middle and high) and is thus determined after step S102 (S104). The predetermined time is set in switching into short, middle or long depending on the decided stage (S105), and step S103 is executed based on the predetermined time thus set. An acceleration may be detected in place of the vehicle speed, and the predetermined time may be switched and set depending on the acceleration. Alternatively, the predetermined time is not switched in discrete steps, but may be changed continuously.

### [Improving Condition R3]

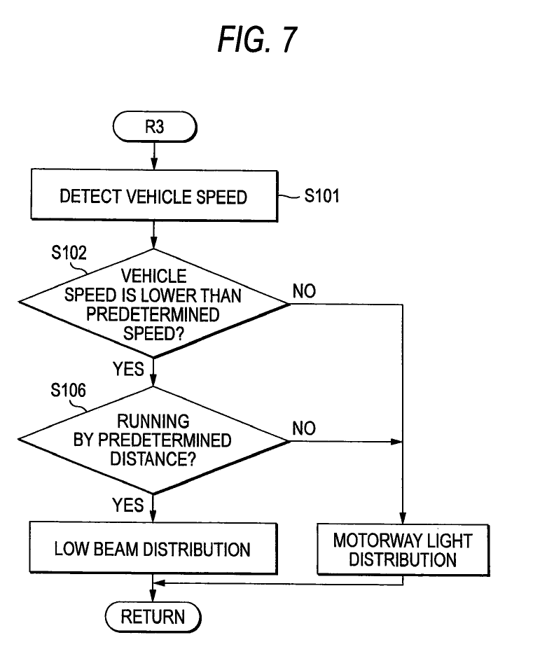

Based on the same purport as the Improving Condition R1, as shown in the flow of FIG. 7, the decision of the “predetermined time” in the flow (FIG. 5) of the Improving Condition R1 (S103) is replaced with a decision of a “predetermined distance” (S107). In view of the fact that the distance from the car to the obstacle (whose presence is confirmed by the driver) is almost constant, when the presence of the obstacle is confirmed, and deceleration is carried out during operation with the “motorway light distribution” so that the vehicle speed is set to be less than a predetermined speed, switching to the “low beam distribution” is not performed, but instead the “motorway light distribution” is maintained until the car travels a sufficient distance to avoid the obstacle. Therefore, illumination for the obstacle is held, and the driver can avoid the danger. In the case of the Improving Condition R1, the time required for the car to avoid the danger varies depending on the reduced vehicle speed. For this reason, it is preferable that the Improving Condition R2 be applied. However, the Improving Condition 3 is based on an actual traveling distance. Regardless of the difference in the reduced vehicle speed it is, therefore, possible to avoid the danger reliably. When the predetermined speed is set to be 60 km/h, the predetermined distance is set to be approximately 30 to 50 m. If the distance is shorter, switching to the “low beam distribution” is carried out before the car reaches the obstacle. Consequently, it is difficult to avoid the danger. The condition deciding portion in the light distribution switching control portion often calculates the “predetermined distance” based on the product of the vehicle speed and a traveling time. Therefore, the Improving Condition R3 is substantially equivalent to the Improving Condition R2.

### [Improving Condition R4]

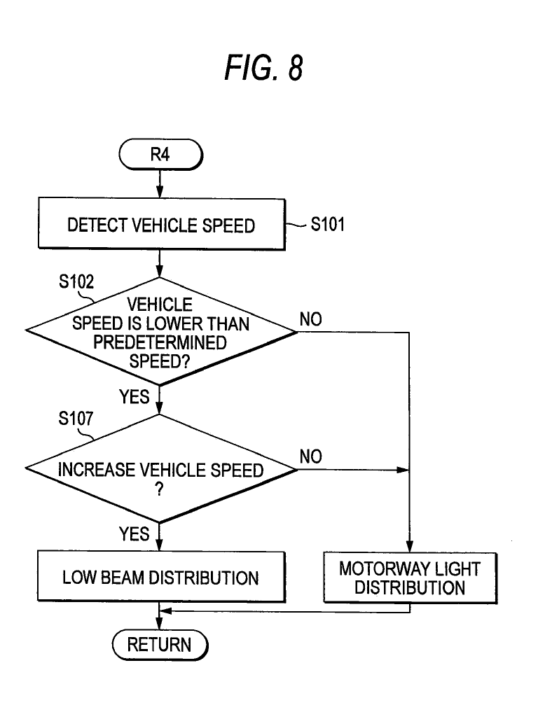

As shown in a flow of FIG. 8, the vehicle speed is detected (S101), and switching to the “motorway light distribution” is carried out based on the detected vehicle speed (S102). When the presence of an obstacle is confirmed and the vehicle is decelerated during operation in the “motorway light distribution” so that the vehicle speed is set to be less than the predetermined speed, the vehicle speed satisfies the basic condition (B3) for switching to the “low beam distribution.” At that time, an increase in the vehicle speed is determined based on vehicle speed information (S107). When the vehicle speed is not increased (including the time that vehicle speed is constant), the “motorway light distribution” is maintained. When the vehicle speed is increased, switching to the “low beam distribution” is carried out. It is estimated that the danger is avoided when the vehicle speed is not increased, that is, when deceleration is applied or the vehicle speed is constant. During that time, therefore, the “motorway light distribution” is maintained to enable confirmation of the presence of an obstacle placed ahead of the car. When the vehicle speed is increased, it is estimated that the danger is avoided completely. Therefore, switching to the “low beam distribution” is carried out, and switching to the “motorway light distribution” is then performed based on the basic condition B3.

### [Improving Condition R5]

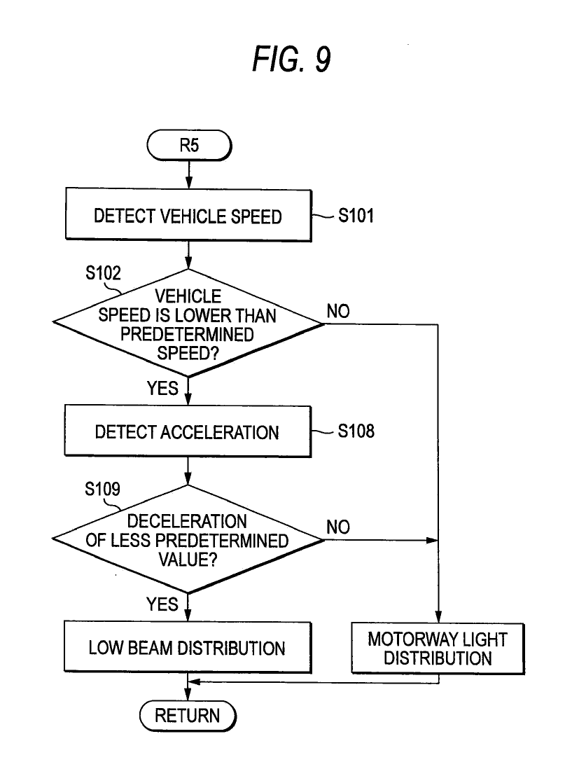

As shown in a flow of FIG. 9, the vehicle speed is detected and operation is carried out in the “motorway light distribution” (S101, S102). When the presence of an obstacle is confirmed, and the vehicle is decelerated during operation so that the vehicle speed is set to be less than the predetermined speed, the vehicle speed satisfies the basic condition (B3) for switching to the “low beam distribution.” At that time, the acceleration is detected from acceleration information (S108) and it is determined whether or not the detected acceleration is a deceleration which is lower than a predetermined value (a state in which the deceleration is low) (S109). If the deceleration is equal to or greater than the predetermined value, the “motorway light distribution” is maintained. If the deceleration is less than the predetermined value, switching to the “low beam distributions is carried out. When the deceleration is equal to or greater than the predetermined value, that is, the deceleration is rapidly applied, it is estimated that there is an emergency and a danger is to be avoided. During that time, therefore, the “motorway light distribution” is maintained to enable the confirmation of the presence of an obstacle placed ahead of the car. When the deceleration is reduced to be less than the predetermined value or acceleration occurs, it is estimated that the danger is completely avoided. Therefore, switching to the “low beam distribution” is carried out and switching to the “motorway light distribution” then is performed based on the basic condition B3.

### [Improving Condition R6]

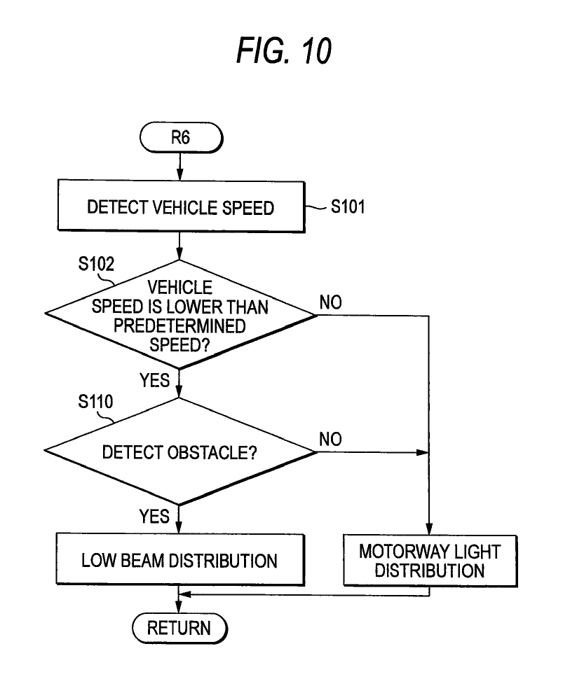

As shown in the flow of FIG. 10, the vehicle speed is detected and the operation is carried out in the “motorway light distribution” (S101, S102). When the presence of an obstacle is confirmed and deceleration is performed during operation so that the vehicle speed is set to be less than the predetermined speed, the vehicle speed satisfies the basic condition (B3) for switching to the “low beam distribution.” At that time, for an improving condition (R6), it is determined whether or not the obstacle is detected by the obstacle sensor SS (S110). If the obstacle is detected by the obstacle sensor SS, the “motorway light distribution” is maintained. When the obstacle is detected, the obstacle located in a forward distant region of the car is illuminated with the “motorway light distribution” to enable the obstacle to be avoided. If the obstacle is not detected by the obstacle sensor SS, switching to the “low beam distribution” is performed. This is effective for detecting the obstacle through the obstacle sensor SS, so that the driver can confirm the presence of the obstacle and avoid the obstacle when the car decelerates if the driver is not convinced of the presence of the obstacle.

### [Improving Condition R7]

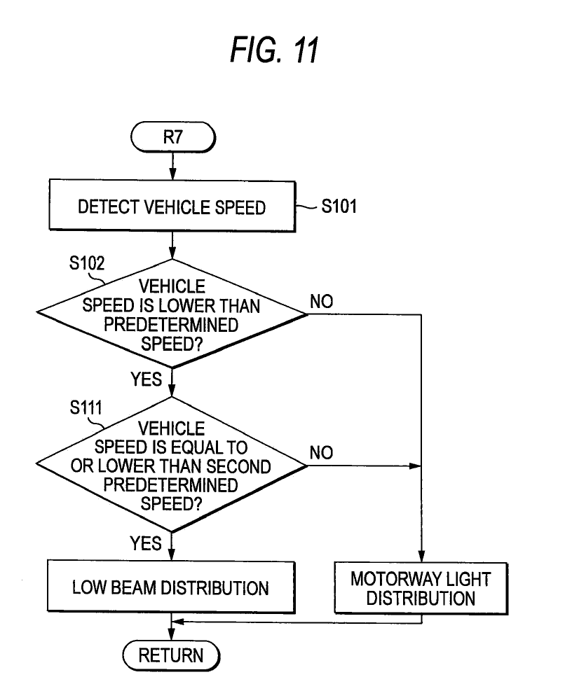

As shown in a flow of FIG. 11, the vehicle speed is detected and operation is carried out in the “motorway light distribution” (S101, S102). When the presence of an obstacle is confirmed and deceleration occurs during operation so that the vehicle speed is set to be less than the predetermined speed, the vehicle speed satisfies the basic condition (B3) for switching to the “low beam distribution.” Also in this case, switching to the “low beam distribution” is not automatically carried out, but it is determined whether the vehicle speed is equal to or less than a second predetermined speed which is less than the predetermined speed (S111). When the vehicle speed is equal to or less than the second predetermined speed, switching to the “low beam distribution” is carried out. Consequently, it is possible to prevent switching to the “low beam distribution” from being immediately carried out upon occurrence of the reference condition (B3) when the vehicle speed is less than the predetermined speed. Thus, it is possible to prevent the light distribution from being switched unnecessarily and to prevent discomfort to the driver.

If the second predetermined speed is set to correspond to the vehicle stopping (i e., a speed of zero) or is set to be such a low speed as to correspond to a slow speed which is close to the vehicle stopping, for example, 10 km/h, the danger is avoided when the presence of the obstacle is confirmed in a high speed operation. In that case, the speed is medium (60 to 30 km/h) and is rarely set to be the stop speed or the low speed, which is close to the slow speed. Therefore, the “motorway light distribution” is maintained during operation at the medium speed to enable confirmation of the obstacle's presence. In an operating state at a speed less than the second predetermined speed, the obstacle is avoided when it is close to the region just ahead of the car. Therefore, switching to the “low beam distribution” is carried out to confirm the presence of the obstacle easily.

While the improving conditions (R1) to (R7) in the light distribution switching control portion are individually set in the example 1, it also is possible to provide a system to select and set an optional improving condition, and the improving condition may be selected by the setting operation of the driver, for example. Alternatively, multiple improving conditions may be combined with each other. In this case, it is important to prevent conflict of the respective improving conditions. For example, it is also possible to employ such a structure so as to set a priority for each of the improving conditions and to decide the improving condition in accordance with the priority through the light distribution switching control portion.

Moreover, the obstacle sensor is not limited to a camera as described according to example 1, but other sensors, such as a millimeter wave radar and a laser radar, can be utilized. Furthermore, the structure for switching the light distribution of the headlamp is not limited to the structure of the movable shade as described above according to example 1, but it is possible to use a structure in which the light distribution is switched by turning ON/OFF an additional lamp (an auxiliary lamp), for example.

Other implementations are within the scope of the claims.

What is claimed is:

1. A lamp system for a vehicle, the lamp system comprising:
a lamp for a vehicle which can switch to at least a low beam distribution and a motorway light distribution, and
a light distribution switching control portion for switching the light distribution based on operational information of the vehicle, wherein the light distribution switching control portion is arranged switch to the low beam distribution when it is determined that the vehicle speed is less than a predetermined speed in the motorway light distribution and a predetermined light distribution switching condition is satisfied.

2. The lamp system for a vehicle according to claim 1, wherein the light distribution switching condition indicates that a predetermined time passes since the vehicle speed is set to be less than the predetermined speed or the vehicle travels a predetermined distance.

3. The lamp system for a vehicle according to claim 2, wherein the predetermined time is varied depending on the speed of the vehicle or its acceleration.

4. The lamp system for a vehicle according to claim 1, wherein the light distribution switching condition indicates that the speed of the vehicle is increased.

5. The lamp system for a vehicle according to claim 1, wherein the light distribution switching condition indicates that the deceleration of the vehicle is set to be less than a predetermined value.

6. The lamp system for a vehicle according to claim 1, wherein the light distribution switching control portion includes obstacle detecting means for detecting an obstacle placed ahead of the vehicle, and the light distribution switching condition indicates that the obstacle is not detected by the obstacle detecting means.
